(19) United States
(12) Patent Application Publication
(10) Pub. No.: US 2007/0204107 A1
(43) Pub. Date: Aug. 30, 2007

(54) Cache memory background preprocessing

(75) Inventors: Zvi Greenfield, Kfar Saba (IL); Yariv Saliternik, Tel Aviv (IL)

Correspondence Address: WOLF GREENFIELD & SACKS, P.C., 600 ATLANTIC AVENUE, BOSTON, MA, 02210-2206, US

(73) Assignee: Analog Devices, Inc., Norwood, MA (US)

(21) Appl. No.: 11/637,232

(22) Filed: Dec. 11, 2006

Related U.S. Application Data
(63) Continuation of application No. 10/785,488, filed on Feb. 24, 2004.

(51) Int. Cl. G06F 12/00

(52) U.S. Cl. 711/128

(57) ABSTRACT

A cache memory preprocessor prepares a cache memory for use by a processor. The processor accesses a main memory via a cache memory, which serves a data cache for the main memory. The cache memory preprocessor consists of a command inputter, which receives a multiple-way cache memory processing command from the processor, and a command implementer. The command implementer performs background processing upon multiple ways of the cache memory in order to implement the cache memory processing command received by the command inputter.

### RELATED APPLICATIONS

This application is a continuation of patent application Ser. No. 10/785,488, titled CACHE MEMORY BACKGROUND PREPROCESSING, filed Feb. 24, 2004 (Attorney Docket No. E0391.70007US00) hereby incorporated by reference.

### FIELD AND BACKGROUND OF THE INVENTION

The present invention relates to performing background operations on a cache memory and, more particularly, to performing background block processing operations on an n-way set associative cache memory.

Memory caching is a widespread technique used to improve data access speed in computers and other digital systems. Data access speed is a crucial parameter in the performance of many digital systems, and in particular in systems such as digital signal processors (DSPs) which perform high-speed processing of real-time data. Cache memories are small, fast memories holding recently accessed data and instructions. Caching relies on a property of memory access known as temporal locality. Temporal locality states that information recently accessed from memory is likely to be accessed again soon. When an item stored in main memory is required, the processor first checks the cache to determine if the required data or instruction is there. If so, the data is loaded directly from the cache instead of from the slower main memory, with very little delay. Due to temporal locality a relatively small cache memory can significantly speed up memory accesses for most programs.

Memory accesses for data present in the cache are quick. However, if the data sought is not yet stored in the cache memory, the required data is available only after it is first retrieved from the main memory. Since main memory data access is relatively slow, each first time access of data from the main memory is time consuming. The processor idles while data is retrieved from the main memory and stored in the cache memory. Additionally, data storage in the cache memory may be inefficient if the cache memory is not ready. For example, in an n-way set associative memory data can be stored in a given way only if the corresponding main memory data is up-to-date. In some cases, therefore, the processor will wait both for data to be retrieved from the main memory and for the cache memory to be prepared for data storage, for example by invalidating the data currently in the cache or by writing the data back into the main memory.

The delays caused by first time accesses of data are particularly problematic for data which is used infrequently. Infrequently used data will likely have been cleared from the cache between uses. Each data access then requires a main memory retrieval, and the benefits of the cache memory are negated. The problem is even more acute for systems, such as DSPs, which process long vectors of data, where each data item is read from memory (or provided by an external agent), processed, and then replaced by new data. In such systems a high proportion of the data is used only once, so that first time access delays occur frequently, and the cache memory is largely ineffective.

When new data is stored in the cache, a decision is made using a cache mapping strategy to determine where the new data will be stored within the cache memory. There are currently three prevalent mapping strategies for cache memories: the direct mapped cache, the fully associative cache, and the n-way set associative cache. In the direct mapped cache, a portion of the main memory address of the data, known as the index, completely determines the location in which the data is cached. The remaining portion of the address, known as the tag, is stored in the cache along with the data. To check if required data is stored in the cached memory, the cache memory controller compares the main memory address of the required data to the tag of the cached data. As the skilled person will appreciate, the main memory address of the cached data is generally determined from the tag stored in the location required by the index of the required data. If a correspondence is found, the data is retrieved from the cache memory, and a main memory access is prevented. Otherwise, the data is accessed from the main memory. The drawback of the direct mapped cache is that the data replacement rate in the cache is generally high, since the way in which main memory data is cached is completely determined by the main memory address of the data. There is no leeway for alleviating contention for the same memory location by multiple data items, and for maintaining often-required data within the cache. The effectiveness of the cache is thus reduced.

The opposite policy is implemented by the fully associative cache, in which the cache is addressable by indices (rows) and cached information can be stored in any index. The fully associative cache alleviates the problem of contention for cache locations, since data need only be replaced when the whole cache is full. In the fully associative cache, however, when the processor checks the cache memory for required data, every index of the cache must be checked against the address of the data. To minimize the time required for this operation, all indices are checked in parallel, requiring a significant amount of extra hardware.

The n-way set associative cache memory is a compromise between the direct mapped cache and the fully associative cache. Like the direct mapped cache, in a set-associative cache the cache is arranged by indices, and the index of the main memory address selects an index of the cache memory. However, in the n-way set associative cache each index contains n separate ways. Each way can store the tag, data, and any indicators required for cache management and control. For example, each way typically contains a validity bit which indicates if the way contains valid or invalid data. Thus, if a way containing invalid data happens to give a cache hit, the data will be recognized as invalid and ignored, and no processing error will occur. In an n-way set associative cache, the main memory address of the required data need only be checked against the address associated with the data in each of the n ways of the corresponding index, to determine if the data is cached. The n-way set associative cache reduces the data replacement rate (as compared to the direct mapped cache) because data in addresses corresponding to the cache memory index can be stored in any of the ways in the index that are still available or contain data that is unlikely to be needed, and requires only a moderate increase in hardware.

Cache memories must handle the problem of ensuring that both the cache memory and the main memory are kept current when changes are made to data values that are stored in the cache memory. Cache memories commonly use one of two methods, write-through and copy-back, to ensure that the data in the system memory is current and that the processor always operates upon the most recent value. The write-through method updates the main memory whenever data is written to the cache memory. With the write-through method, the main memory always contains the most up-to-date data values. The write-through method, however, places a significant load on the data buses, since every data update to the cache memory requires immediate updating of the main memory as well. The copy-back method, on the other hand, updates the main memory only when data which has been modified while in the cache memory, and which therefore is more up-to-date than the corresponding main memory data, is replaced. Copy-back caching saves the system from performing many unnecessary write cycles to the main memory, which can lead to noticeably faster execution. However, copy-back caching can increase the time required for the processor to read in large data structures, such as large vectors of numbers, because data currently in the cache may have to be written back to memory before the new values can be stored in the cache.

Referring now to the drawings, FIG. 1 illustrates the organization of a 2-way set associative memory. The associative memory is organized into M indices, where the number of indices is determined by general hardware design considerations. Each of the M indices contains two ways, although in the general case of an n-way set associative memory, each index would have n ways. The information stored in each way has several components. As described above, each way stores the data and an associated tag. Together, the index and the tag determine the main memory address of the stored data in a given way. Each way contains additional bits, such as the validity bit, which provide needed information concerning the stored data. If the copy-back memory updating method is used, a dirty bit is stored for each way. Additional indicators may also be provided for each way or for each index.

In order to prevent processor idling during data access, Intel® developed the Merced “Hoist” operation, which downloads a single entry from the main memory into the cache memory in parallel with other processor operations. When the processor later requires the data, the cache is ready and the data is available rapidly.

An operation similar to the Intel® Hoist operation is described in U.S. Pat. No. 5,375,216 by Moyer et al. which describes an apparatus and method for optimizing performance of a cache memory in a data processing system. In Moyer's system, cache control instructions have been implemented to perform touch load, flush, and allocate operations in the data cache. A cache pre-load, or “touch load,” instruction allows a user to store data in the cache memory system before the data is actually used by the data processing system. The touch load instruction allows the user to anticipate the request for a data value and store the data value in the cache memory such that delays introduced during a load operation may be minimized. Additionally, while the data value is retrieved from the source external to the data processing system, the data processing system may concurrently execute other functions.

Both Intel's® Hoist operation and Moyer et al.'s pre-load operation can reduce processor delays by preparing a data item in the cache memory outside normal processing flow. However since each operation stores only a single data value in the cache, these operations are inefficient for cases in which large quantities of data are needed, such as in the above-mentioned case of the DSP and large vectors. Preparing a large quantity of data in the cache memory for processor use requires issuing multiple Hoist (or pre-load) commands, one for each required data item, which itself slows down the processor.

There is thus a widely recognized need for, and it would be highly advantageous to have, a cache memory system devoid of the above limitations.

### SUMMARY OF THE INVENTION

According to a first aspect of the present invention there is provided a cache memory preprocessor which prepares a cache memory for use by a processor. The processor accesses a main memory via a cache memory, which serves a data cache for the main memory. The cache memory preprocessor consists of a command inputter, which receives a multiple-way cache memory processing command from the processor, and a command implementer. The command implementer performs background processing upon multiple ways of the cache memory in order to implement the cache memory processing command received by the command inputter.

According to a second aspect of the present invention there is provided a background memory refresher which updates main memory data in accordance with data cached in a cache memory. The cache memory is arranged in blocks. The background memory refresher consists of a command inputter, which receives a block update command, and a block updater. The block updater performs background update operations in a blockwise manner. The main memory is updated in accordance with data cached in a specified block of the cache memory.

According to a third aspect of the present invention there is provided a cache memory background block preloader, for preloading main memory data arranged in blocks into a cache memory. The block preloader consists of a command inputter, which receives a block initialize command, and a cache initializer. The cache initializer performs background caching of data from a specified block of main memory into the cache memory.

According to a fourth aspect of the present invention there is provided a processing system, which processes data from a segmented memory. The processing system consists of a segmented memory, a processor, a cache memory preprocessor, and a switching grid-based interconnector. The segmented memory contains a plurality of memory segments, each segment having a respective data section and a respective cache memory section. The processor processes data, performs read and write operations to the segmented memory, and controls processing system components. The processor accesses memory segments via the respective cache memory section. The cache memory preprocessor prepares the cache memory sections for use by the processor. The cache memory preprocessor prepares a memory section by performing background processing upon multiple ways of at least one of the cache memory sections, in accordance with a multiple-way cache memory processing command received from the processor. The switching grid-based interconnector provides in parallel switchable connections between the processor and the cache memory preprocessor, to selectable memory segments.

According to a fifth aspect of the present invention there is provided a method for preparing a cache memory by receiving a cache memory processing command which specifies background processing of multiple ways of the cache memory, and performing background processing upon multiple ways of the cache memory so as to implement the multiple-way cache memory processing command.

According to a sixth aspect of the present invention there is provided a method for updating main memory data from cached data. The cache memory is arranged in blocks. The method is performed by receiving a block update cache memory processing command, and performing background update operations in a blockwise manner to update the main memory in accordance with data cached in a specified block within the cache memory

According to a seventh aspect of the present invention there is provided a method for caching main memory data of a main memory into a cache memory. The main memory is arranged in blocks. The method is performed by receiving a block initialize cache memory processing command, and performing background blockwise caching of data of a main memory block specified in the command into the cache memory.

According to an eighth aspect of the present invention there is provided a program instruction for cache memory block preprocessing. The program instruction contains operands defining a cache memory blockwise processing operation, and a memory block for performing the processing operation upon. The instruction has low priority, so that executing the instruction does not interfere with higher priority commands.

According to a ninth aspect of the present invention there is provided a compiler that supports program instructions for cache memory block preprocessing. The compiler compiles instruction sequences containing instructions taken from a predefined set of instructions into executable form. The instruction set includes a cache memory block preprocessing instruction. The block preprocessing instruction has operands defining a cache memory blockwise processing operation, and a memory block for performing the processing operation upon. The block preprocessing instruction has low priority, so that executing the preprocessing instruction does not interfere with higher priority commands.

The present invention addresses the shortcomings of the presently known configurations by providing a cache memory preprocessing apparatus and method which prepares the cache memory without interfering with processor instruction execution. Cache memory preprocessing readies the cache memory for future processor requirements, thereby improving cache memory response times to processor requests.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates the organization of a 2-way set associative memory.

FIG. 2 illustrates a conventional processing system with cache memory.

FIG. 3 is a simplified block diagram of a preferred embodiment of a cache memory preprocessor, according to a preferred embodiment of the present invention.

FIG. 4 is a simplified block diagram of a processing system with a system memory containing a cache memory preprocessor, according to a preferred embodiment of the present invention.

FIG. 5 is a simplified block diagram of a preferred embodiment of a cache memory preprocessor with prioritizer, according to a preferred embodiment of the present invention.

FIG. 6 is a simplified block diagram of a block updater, according to a preferred embodiment of the present invention.

FIG. 7 is a simplified block diagram of a cache initializer, according to a preferred embodiment of the present invention.

FIG. 8 is a simplified block diagram of a processing system with a background memory refresher, according to a preferred embodiment of the present invention.

FIG. 9 is a simplified block diagram of a processing system with a cache memory background block preloader, according to a preferred embodiment of the present invention.

FIG. 10 is a simplified block diagram of a processing system with a segmented memory, according to a preferred embodiment of the present invention.

FIG. 11 is a simplified block diagram of a segmented memory processing system with a cache memory preprocessor, according to a preferred embodiment of the present invention.

FIG. 12 is a simplified flow chart of a method for preparing a cache memory, according to a preferred embodiment of the present invention.

FIG. 13 is a simplified flow chart of a method for updating main memory data in accordance with cached data according to a preferred embodiment of the present invention.

FIG. 14 is a simplified flow chart of a method for caching main memory data in a cache memory according to a preferred embodiment of the present invention.

FIG. 15 is a simplified flow chart of a method for invalidating data in a cache memory, according to a preferred embodiment of the present invention.

FIG. 16 is a simplified flow chart of a method for updating main memory data from cached data, according to a preferred embodiment of the present invention.

FIG. 17 is a simplified flow chart of a method for caching main memory data in a cache memory, according to a preferred embodiment of the present invention.

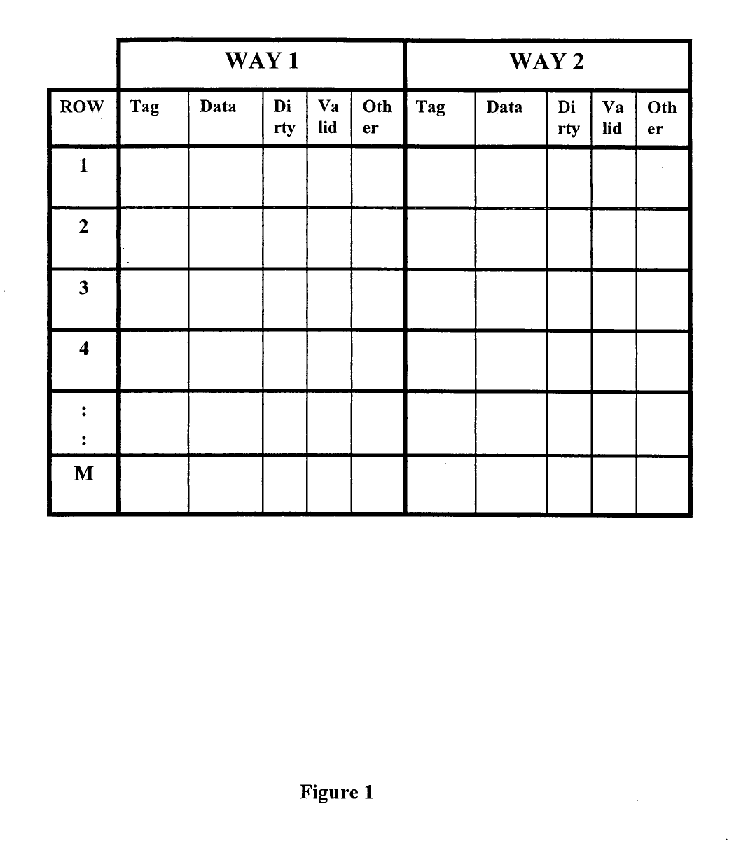

### DESCRIPTION OF THE PREFERRED EMBODIMENTS

The present embodiments comprise a cache memory preprocessing system and method which prepares blocks of a cache memory for a processing system outside the processing flow, but without requiring the processor to execute multiple program instructions. Cache memories serve to reduce the time required for retrieving required data from memory. However a cache memory improves data access times only if the required data is already stored in the cache memory. If the required data is not present in the cache, the data must first be retrieved from the main memory, which is a relatively slow process. Delays due to other cache memory functions may also be eliminated, if performed in advance and without processor involvement. The purpose of the present invention is to prepare the cache memory for future processor operations with a single processor command, so that the delays caused by waiting for data to be loaded into the cache memory and by other cache memory operations occur less frequently.

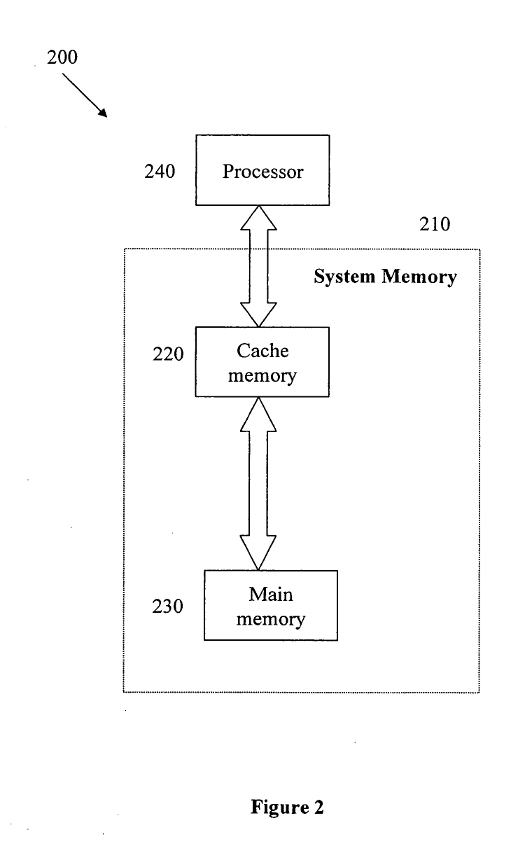

Reference is now made to FIG. 2 which illustrates a conventional processing system with cache memory. FIG. 2 shows a system 200 in which the system memory 210 is composed of both a fast cache memory 220 and a slower main memory 230. When processor 240 requires data from the system memory 210, the processor first checks the cache memory 220. Only if the memory item is not found in the cache memory 220 is the data retrieved from the main memory 230. Thus, data which was previously stored in the cache memory 220 can be retrieved quickly, without accessing the slow main memory 230.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In many cases it is possible for a processing system designer to know, at a certain point in the program flow, that certain data will be required several program instructions later. In present systems this knowledge is not used, and any main memory data that is retrieved from main memory is loaded into the cache when the program instruction calling for the data is reached. The processor idles while the data is loaded into the cache memory, and instruction execution is delayed. The present embodiments enable the system designer to use his knowledge of overall system operation, and specifically of the instruction sequence being executed by the processor, to load data into the cache memory in advance of the time the data is actually needed by the processor. If the data is preloaded into the cache, the processor can proceed with instruction execution without needing to access the slow main memory. The cache memory preprocessor performs the task of preparing the cache memory for the processor, with minimal processor involvement. The cache memory preprocessor operates in the background, outside of main processor control, similarly to direct memory access (DMA). Preferably the cache memory preprocessor performs the background operations needed to implement the cache memory processing command with low priority, so that other processing tasks are not interfered with.

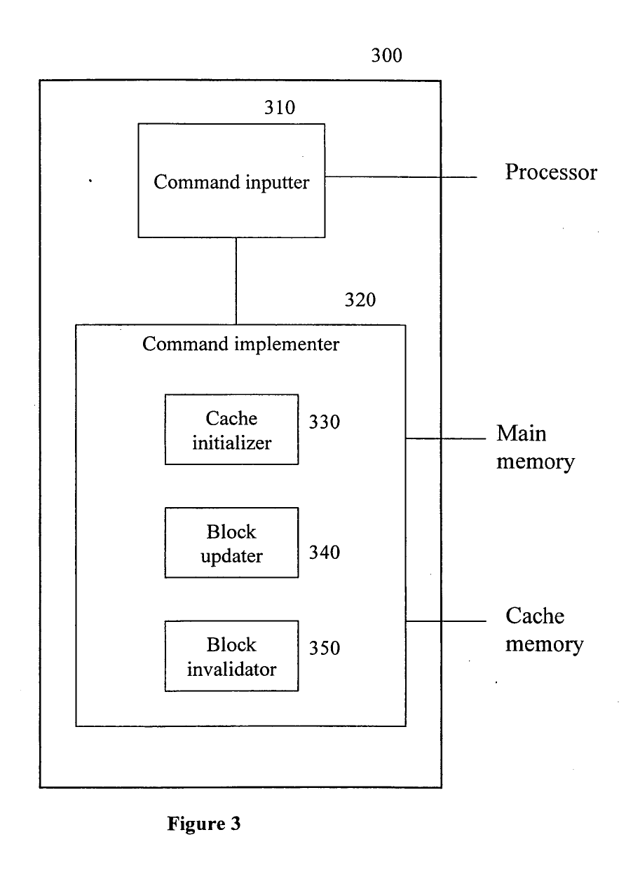

Reference is now made to FIG. 3, which is a simplified block diagram of a preferred embodiment of a cache memory preprocessor 300 for preparing a cache memory for use by a processor according to a preferred embodiment of the present invention. The processor accesses the system main memory via the cache memory, which provides data caching for the main memory. The cache memory may be a direct mapped cache, a fully associative cache, or an n-way set associative cache, or may organized by any other desired mapping strategy. A single processor instruction causes the processor to send a multiple-way cache memory processing command to the cache memory preprocessor 300. Using a single command to perform an operation on multiple ways is more efficient than sending a series of single-way processing commands, since sending a series of cache commands stalls other tasks.

The processing command specifies a memory operation and command-specific parameters, such as blocks within the cache and/or main memories upon which the specified operation should be performed. A cache memory block consists of consecutively ordered cache memory ways, whereas a main memory block consists of a consecutively addressed main memory locations. The multiple-way processing command triggers the cache memory preprocessor 300, which then works in the background and performs the specified memory operation. Required memory functions are thus accomplished on memory blocks, with minimal processor involvement.

Cache memory preprocessor 300 contains command inputter 310 and command implementer 320. Command inputter 310 receives the processing command from the processor. The command specifies the operation to be performed on the cache memory, and may also include a set of parameters specific to the required operation. For example, to invalidate the data in a block of ways of the cache memory, the command sent by the processor to the cache memory preprocessor 300 specifies the invalidate operation and a block of cache memory ways on which the invalidate operation should be carried out. The block of cache memory ways can be specified in any manner consistent with system architecture, for example by specifying a start address and a stop address, or by specifying a start address and the block size. For other commands, blocks of main memory addresses may be specified in a likewise manner. The command parameters can be passed to the cache memory preprocessor 300 directly by the processor, or they can be stored in a register by the processor and then read from the register by the command inputter 310.

After a command is received, the command is performed upon the cache memory as a background operation by the command implementer 320. The memory operations performed by command implementer 320 affect a group of ways (or indices) of the cache memory. The group of ways may or may not be at consecutive addresses within the cache memory. For example, in an n-way set associative consecutively addressed main memory data is not stored in a consecutive ways of the cache memory, but rather in consecutive indices. Thus a command to an n-way set associative cache memory, such as the block initialize command described below, which is defined for a block of main memory addresses will affect multiple, but non-consecutive, ways. Command implementer 320 may include further components, such as the cache initializer 330, block updater 340, and block invalidator 350, for implementing specific processing commands. The operation of the cache memory preprocessor 300 is described in more detail below.

Command implementer 320 works in the background, to access and control the cache memory and the main system memory. Command implementer 320 may read and write data into both the main and cache memories, and may also perform cache memory control functions, such as clearing and setting validity and dirty bits. In the preferred embodiment, command implementer 320 contains several components, each one dedicated to performing a single preprocessing command.

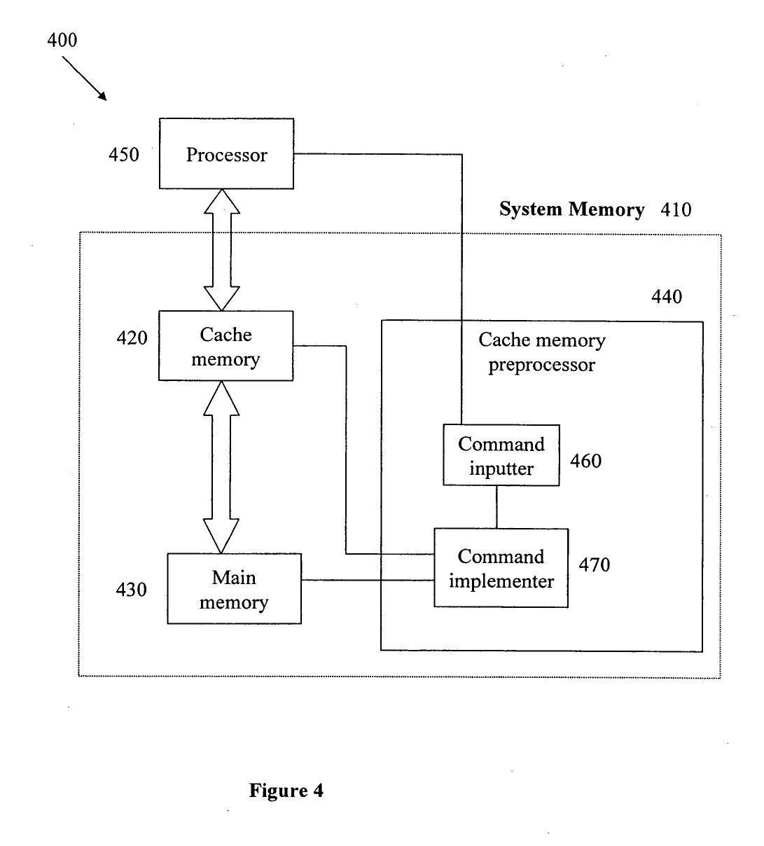

Reference is now made to FIG. 4, which is a simplified block diagram of a processing system 400 with a system memory containing a cache memory preprocessor, according to a preferred embodiment of the present invention. FIG. 4 shows how the cache memory preprocessor 440 is integrated into the processing system. In the preferred embodiment, system memory 410 includes cache memory 420, main memory 430, and cache memory preprocessor 440. Processor 450 accesses main memory 430 via cache memory 420, which serves as the system cache memory. Cache memory preprocessor 440 operations are triggered by processing commands which are received by command inputter 460 from the processor 450. After receiving a processing command, the command inputter 460 activates the command implementer 470, which in turn controls the cache memory 420 and the main memory 430. Command implementer 470 operates in the background, and accesses the cache and main memories when they are not busy with higher priority activities.

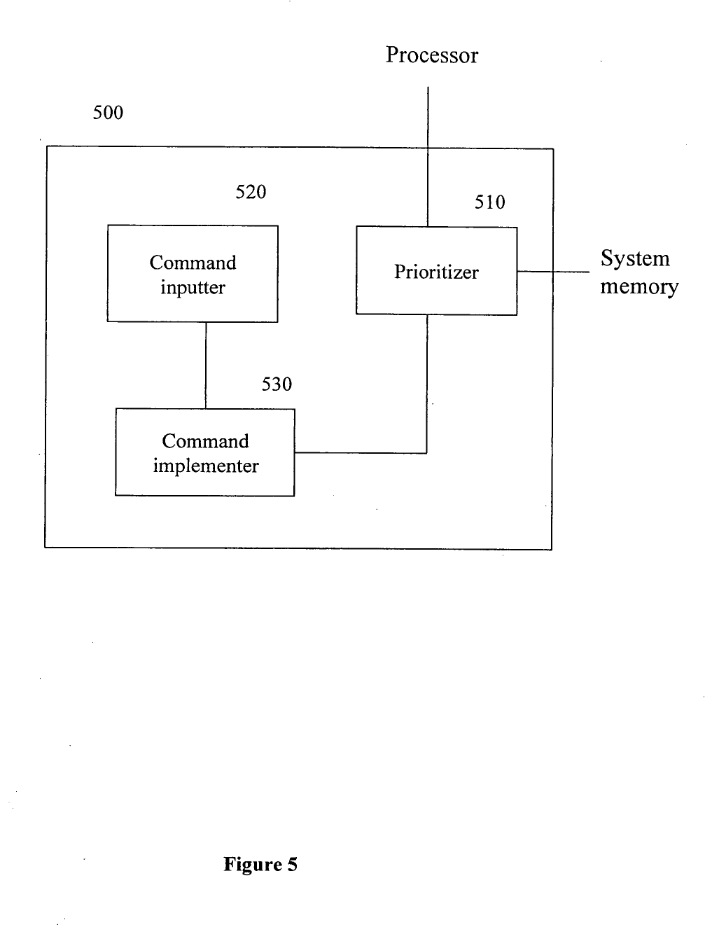

Reference is now made to FIG. 5, which is a simplified block diagram of a preferred embodiment of a cache memory preprocessor with prioritizer, according to a preferred embodiment of the present invention. In the preferred embodiment of FIG. 5, cache memory preprocessor 500 contains a prioritizer 510, in addition to the command inputter 520 and command implementer 530 described above. Prioritizer 510 uses a priority scheme to control command implementer 530 and processor access to the cache memory. Prioritizer 510 ensures that cache memory preprocessor 500 does not interfere with other, higher priority processor communications with the system memory. The prioritizer 510 ensures that the cache memory preprocessor 500 can access and control the cache and main memories only during bus cycles in which the processor, or any other higher priority processing agent, is not reading from or writing to the cache memory.

In the preferred embodiment, the command implementer comprises a block updater, a block invalidator, and/or a cache initializer, for implementing the block update, block invalidate, and block initialize cache memory processing commands respectively. The block updater updates the main memory with data from a block of ways of the cache memory which are specified in the block update processing command. The block invalidator invalidates cache memory data in a block of ways (or indices) of the cache memory which are specified in the invalidate processing command. The cache initializer loads data from a block of main memory specified in the block initialize processing command into the cache memory.

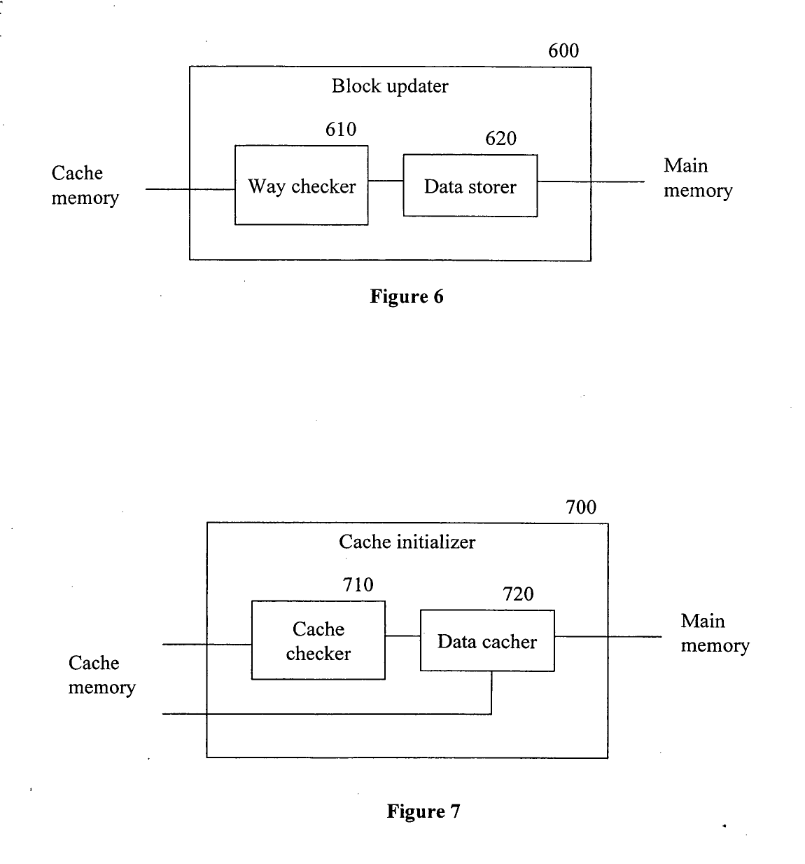

Reference is now made to FIG. 6, which is a simplified block diagram of a block updater, according to a preferred embodiment of the present invention. Block updater 600 implements the block update cache memory processing command. Block updater 600 checks each way in a specified block of cache memory ways to determine if the corresponding main memory data is up-to-date, and updates main memory data for those ways for which the data is not up-to-date. Updating main memory data serves two purposes. First, updating the data ensures that main memory data is consistent with the up-to-date values stored in the cache memory. Secondly, the specified ways are freed for data replacement. That is, new data can be stored in one of the freed ways without requiring a time-consuming main memory update.

In the preferred embodiment block updater 600 consists of a way checker 610 and a data storer 620. Way checker 610 determines for a given way if the corresponding main memory data is up-to-date, or should be updated to the cached value, typically by the copy-back method. In the preferred embodiment way checker determines if the way data and the corresponding main memory data are equivalent by checking the way's dirty bit. If the main memory data is current, no refreshing is needed for that way. When the cache memory is an n-way set associative memory, the way checker may operate per index, to check all the ways of a selected index. If the data is not current, data storer 620 copies the data from the given way into the main memory. In the preferred embodiment data storer 620 stores the data from the given way in the main memory into the associated main memory address, and also preferably resets the way's dirty bit.

Reference is now made to FIG. 7, which is a simplified block diagram of a cache initializer, according to a preferred embodiment of the present invention. Cache initializer 700 implements the block initialize cache memory processing command, and preloads a block of main memory data into the cache memory. Cache initializer 700 checks the cache memory for each main memory address in a specified block of main memory addresses to determine if the data at the main memory address is currently cached in the cache memory. If the main memory data is not cached, the main memory data at that address is cached in the cache memory. When the data is required, several instructions later in program flow, no main memory accesses are needed. If, due to system processing load, the cache initializer 700 is unable to preload some or all of the required memory data, the missing data is loaded in the standard manner into the cache at the time it is required by the processor.

In the preferred embodiment, the cache initializer 700 contains cache checker 710 and data cacher 720. Cache checker 710 determines if data from a specified main memory address is present in the cache memory, preferably by checking the cache memory for a cache hit for the given main memory address. Data cacher 720 caches the data from a given main memory address in the cache memory as necessary.

In the preferred embodiment, the cache memory preprocessor contains a block invalidator (350 of FIG. 3), which implements the invalidate cache memory processing command by invalidating data in a specified group of ways of the cache memory. The block invalidate command specifies a block of ways for which the data is to be invalidated. The block invalidator invalidates the data in each way, preferably by setting the way's validity bit to invalid. A way containing invalidated data will not return a cache hit, and is therefore free for new data storage. Invalidating a way is generally quicker than copying-back way data, since no checking of way status or accesses of main memory data are required.

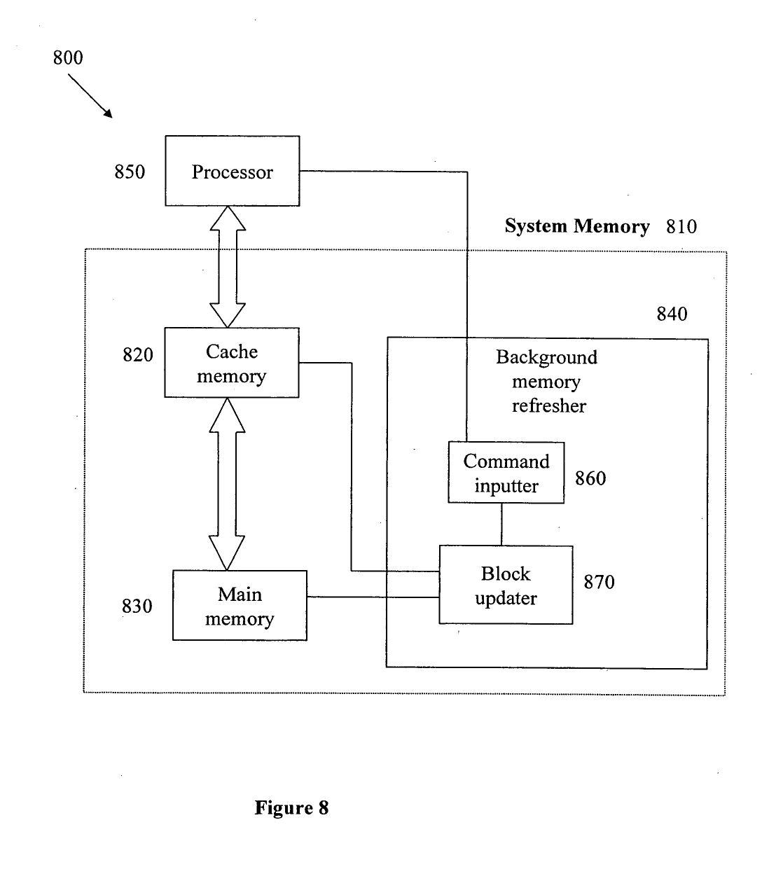

Reference is now made to FIG. 8, which is a simplified block diagram of a processing system 800 with a cache memory preprocessor consisting of a background memory refresher 840, according to a preferred embodiment of the present invention. Memory refresher 840 performs only the block update cache memory preprocessing task, to update the main memory in accordance with data from a specified block of cache memory ways. Memory refresher 840 consists of a command inputter 860 and block updater 870, which operate similarly to those described above. System memory 810 includes cache memory 820, main memory 830, and memory refresher 840, where cache memory 820 may be implemented by any type of cache memory device. Memory refresher 840 operations are triggered only by the block update processing command, which is received by command inputter 860 from the processor 850. After receiving a block update command, the command inputter 860 activates the block updater 870, which checks each way in the specified block of cache memory ways to determine if the corresponding main memory data is up-to-date, and copies data into the main memory for those ways for which the data is not up-to-date. Preferably, block updater 870 comprises a way checker and a data storer, which operate as described for the block updater above. Block updater 870 operates in the background, without further processor involvement, and accesses the cache and main memories when they are not busy with higher priority activities.

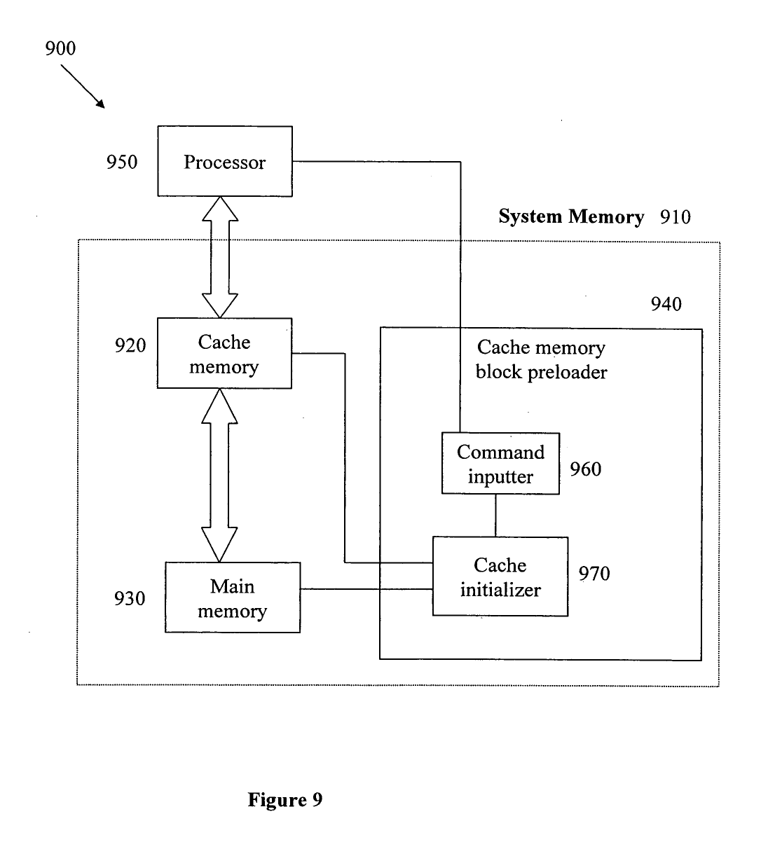

Reference is now made to FIG. 9, which is a simplified block diagram of a processing system 900 with a cache memory preprocessor consisting of a cache memory background block preloader 940, according to a preferred embodiment of the present invention. Block preloader 940 performs only the block initialize cache memory preprocessing task, to load data from a block of the main memory into the cache memory. Block preloader 940 consists of a command inputter 960 and cache initializer 970, which perform similarly to those described above. The system memory 910 includes cache memory 920, main memory 930, and block preloader 940, where cache memory 920 may be implemented by any type of cache memory device. The main memory addresses are specified in a block initialize processing command sent by processor 950. After receiving the block initialize command, the command inputter 960 activates the cache initializer 970. Cache initializer 970 checks each main memory address in the specified block to determine if the main memory data is cached in the cache memory, and caches any data not found in the cache memory. Preferably, cache initializer 970 comprises a cache checker and a data cacher which operate as described for the cache initializer above. Cache initializer 970 operates in the background, and accesses the cache and main memories when they are not busy with higher priority activities.

In the preferred embodiment the cache memory preprocessor is configured to work as part of a processing system with a segmented system memory. In a segmented memory, the system memory is subdivided into a number of segments which can be accessed independently. Parallel access to the memory segments can be provided to a number of processing agents, such as processors and I/O devices, so that multiple memory accesses can be serviced in parallel. Each memory segment contains only a portion of the data. A processor accessing data stored in the memory must address the relevant memory segment.

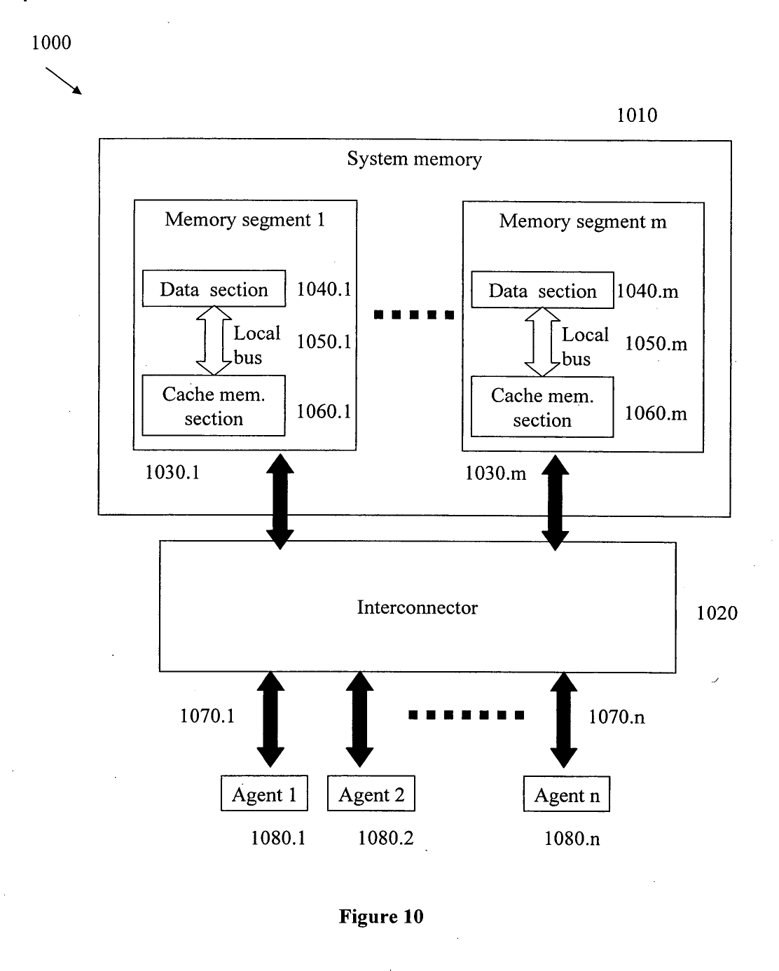

Segmented memory is often cached in more than one cache memory within the processing system. Using a single cache for the entire memory can interfere with parallel access to the memory segments, since all of the processing agents are required to access the main memory through the single cache memory. In the preferred embodiment, each memory segment has a dedicated cache memory, through which the memory segment's data is accessed. An interconnector provides parallel connections between the processing agents and the memory segments. FIG. 10 illustrates the processing system architecture of the present embodiment.

Reference is now made to FIG. 10, which is a simplified block diagram of a processing system with a segmented memory, according to a preferred embodiment of the present invention. The number of memory segments and outputs is for purposes of illustration only, and may comprise any number greater than one. Processing system 1000 consists of a segmented memory 1010 and an interconnector 1020. The memory segments, 1030.1-1030.m, each have a data section 1040 containing the stored data, and a cache memory section 1060 serving as a local cache memory for the memory segment. Preferably, the cache memory section consists of an n-way set associative memory. The data section 1040 and cache memory section 1060 of each memory segment are connected together, preferably by a local data bus 1050. The memory segments 1030.1-1030.m are connected in parallel to the interconnector 1020, which connects between the segmented memory 1010 and the processing agents. In the preferred embodiment, the number of the memory segments (1030.1-1030.m) is equal to or greater than the number of interconnector outputs (1070.1-1070.n). The interconnector outputs are connected to processing agents, 1090.1-1090.n, such as processors, processing elements, and I/O devices.

In the preferred embodiment, interconnector 1020 is a switching grid, such as a crossbar, which provides parallel switchable connections between the interconnector terminals and the memory segments. When interconnector 1020 receives a command to connect a terminal to a specified memory segment, internal switches within interconnector 1020 are set to form a pathway between the terminal and the memory segment. In this way, parallel connections are easily provided from the memory segments to the processing agents at the interconnector outputs. Interconnector 1020 controls processing agent access to the memory segments, in order to prevent collision between agents attempting to access a single memory segment simultaneously. In the preferred embodiment, the interconnector 1020 contains a prioritizer which prevents more than one agent from connecting to a single memory segment simultaneously, but instead connects agents wishing to connect to the same memory segment sequentially, according to a priority scheme. The priority scheme specifies which agents are given precedence to the memory segments under the current conditions.

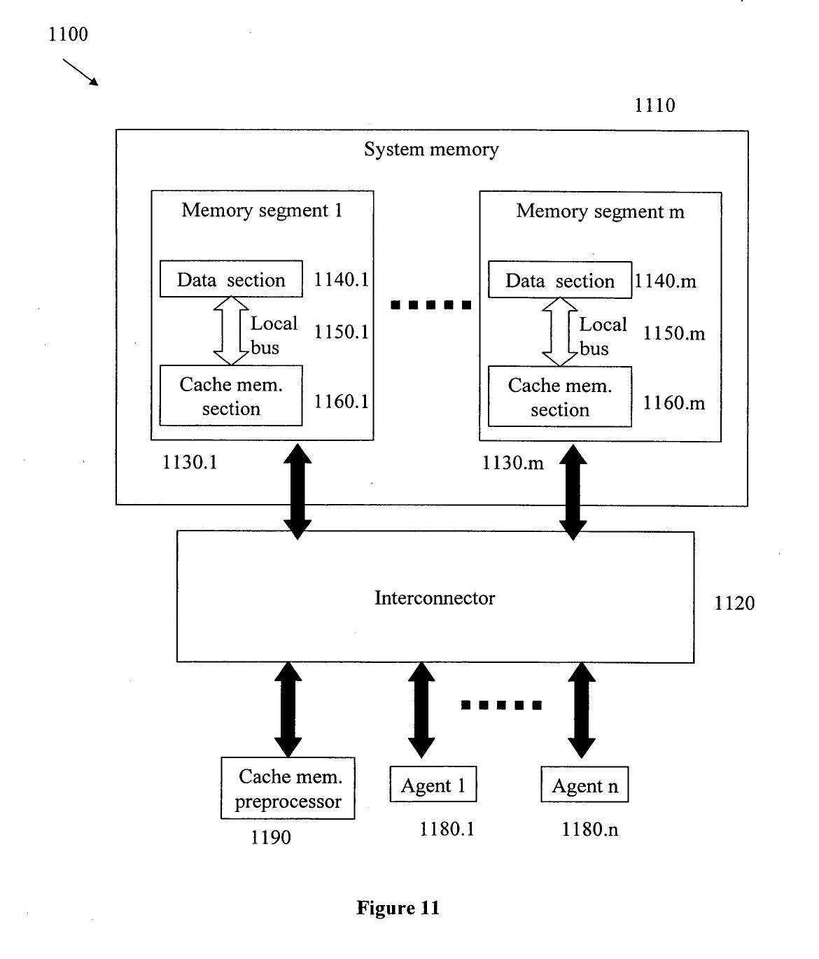

Utilizing a cache memory preprocessor with a segmented memory system architecture is relatively simple. The cache memory preprocessor acts as one of the system processing agents. Reference is now made to FIG. 11, which is a simplified block diagram of a segmented memory processing system with a cache memory preprocessor, according to a preferred embodiment of the present invention. The structure of FIG. 11 is similar to that of FIG. 10, with the addition of the cache memory processor 1190 at one of the interconnector 1120 terminals. The cache memory preprocessor 1190 addresses the required memory segment through the interconnector 1120. Cache memory preprocessor 1190 is assigned a low priority, and so is allowed access to a memory segment 1130.x only if the segment is not being accessed by another, higher priority processing agent. Commonly the number of processing agents in the system is less than the number of memory segments. Memory segmentation thus can improve the likelihood that cache memory preprocessor 1190 will obtain access to the cache memory, since at any bus cycle some of the segments are not connected to a processing agent, and hence are free for cache memory preprocessor 1190 access. Note that a single command received from the processor may cause the cache memory preprocessor 1190 to prepare more than one cache memory section, since the memory parameters specified by the command may concern more than one memory segment.

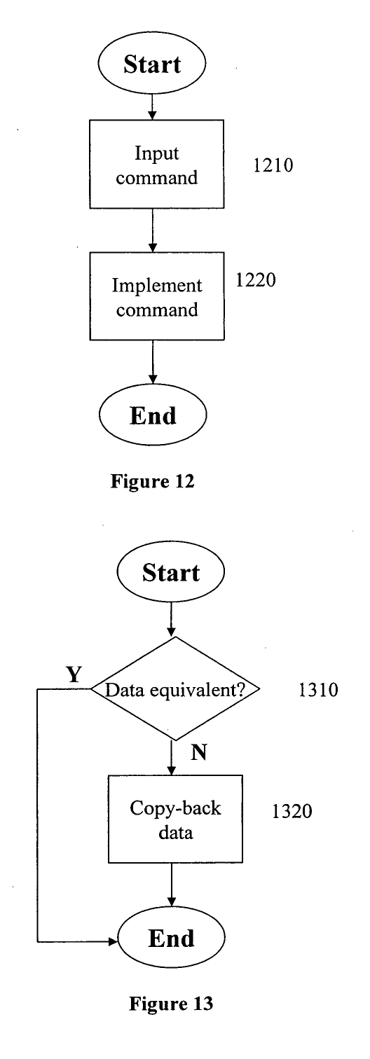

Reference is now made to FIG. 12 which is a simplified flow chart of a method for preparing a cache memory, according to a preferred embodiment of the present invention. As discussed above, performing certain operations upon blocks of a cache memory can improve the efficiency of the caching process. For example, preloading a block of data into a cache memory prior to the data's being required by the processor eliminates processor idling while waiting for data to be loaded. In step 1210 a cache memory processing command is received from a system processor. The processing command is generated by a single processing instruction, which is inserted into the instruction sequence by the system programmer. In response to the received command, the command is implemented via background processing which is performed upon multiple ways of the cache memory in step 1220. FIGS. 13-15 depict preferred embodiments of processing steps which are performed in response to specific processing commands.

The above method is performed as background processing. After sending the processing command that initiates cache memory preparation the processor continues executing subsequent instructions. To ensure that cache memory preparation does not interfere with the other processor tasks, communications with the cache memory must be controlled. The cache preparation method preferably contains the further step of controlling communications to the cache memory device according to a predetermined priority scheme. The priority scheme ensures that if processor commands and cache preparations commands are sent to the cache memory simultaneously, the higher priority processor commands will reach the cache memory first, and the cache memory preparation commands will reach the cache memory only when it is not occupied with other tasks.

Reference is now made to FIG. 13 which is a simplified flow chart of a method for implementing the block update command, according to a preferred embodiment of the present invention. The block update method utilizes the data from a specified block of ways to update the main memory as necessary. The block update command specifies a block of ways of the cache memory. The following steps are performed for each way in the specified block of ways. In step 1310 the way is checked to determine if the data cached in the way is equivalent to corresponding main memory data. If the cached data and the respective main memory data are not equivalent, the main memory data is updated in step 1320. Updating main memory data can be performed in any manner, but preferably is performed by replacing the data at the corresponding main memory address with the cached data value, and resetting the way's dirty bit.

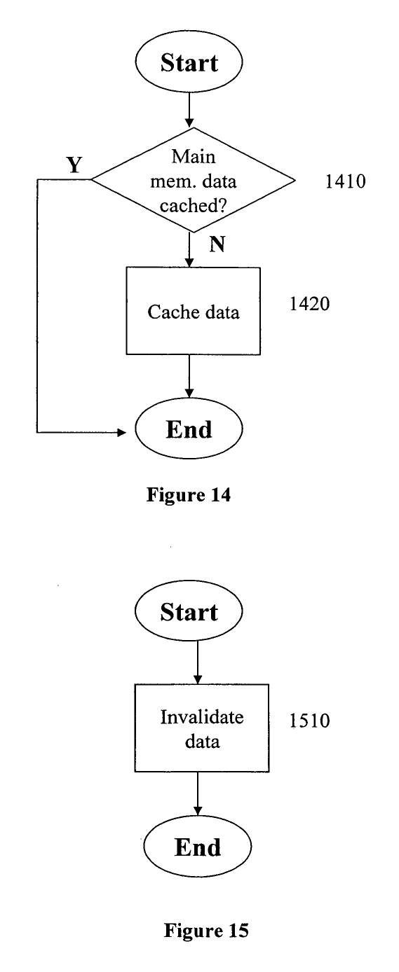

A similar method is performed in response to a received block initialize processing command. The block initialize command loads the data from a specified block of the main memory into the cache, in readiness for future processor operations. Reference is now made to FIG. 14 which is a simplified flow chart of a method for implementing the block initialize command by caching specified main memory data in the cache memory according to a preferred embodiment of the present invention. The following steps are performed for each main memory address in the specified block of main memory. In step 1410 the data at the current main memory address checked to determine if the data is cached in the cache memory, preferably by checking the cache memory for a cache hit. If step 1410 finds that the data is not yet cached, the main memory data is cached in the cache memory in step 1420.

Reference is now made to FIG. 15 which is a simplified flow chart of a method for invalidating data in a specified block of ways of the cache memory in response to an invalidate processing command according to a preferred embodiment of the present invention. The invalidation method consists of a single step which is performed for each of the ways in the specified block. In step 1510 the data for each way is invalidated, preferably by setting a validity bit of the way to invalid.

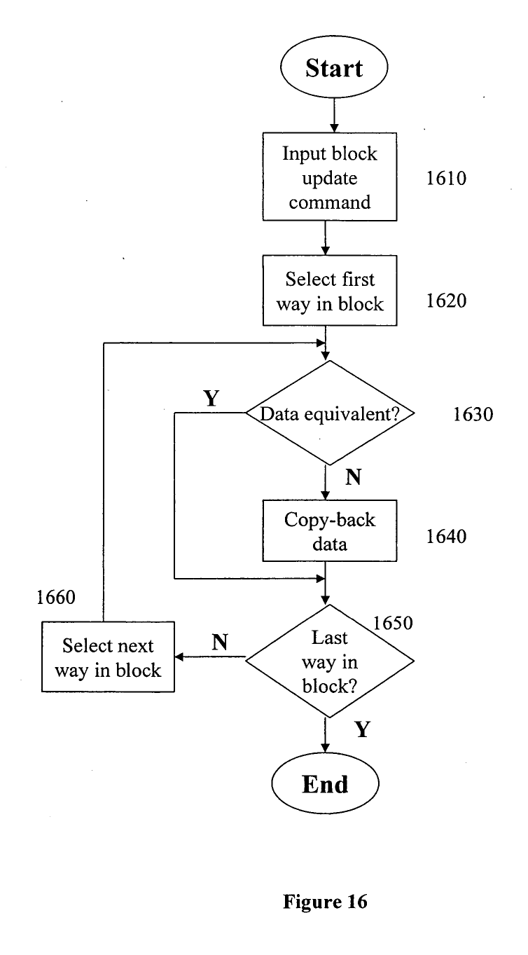

In a preferred embodiment only the block update command is implemented for any type of cache memory. Reference is now made to FIG. 16 which is a simplified flow chart of a method for updating main memory data from cached data in response to a block update cache memory processing command according to a preferred embodiment of the present invention. FIG. 16 shows the complete method performed when a block update command is received, combining the methods of FIGS. 12 and 13 above. In step 1610 the block update cache memory processing command is received. The block update command is typically implemented by performing background copy-back operations on the specified block of the cache memory. The method of FIG. 16 ensures that the main memory data corresponding to the data cached in the specified block of the cache memory is up-to-date.

Steps 1620-1650 show a preferred embodiment of block update command implementation. In step 1620 the first way in the specified block of ways is selected. In step 1630, the selected way is checked to determine if the data cached in the way is equivalent to corresponding main memory data. If the data is not equivalent, the main memory data is updated to the cached data value in step 1640. If the data is equivalent, step 1640 is skipped. Step 1650 checks if all the ways in the specified block have been processed. If not, the next way in the block is selected in step 1660, and the process continues at step 1630. If the end of the block of ways has been reached, the method ends.

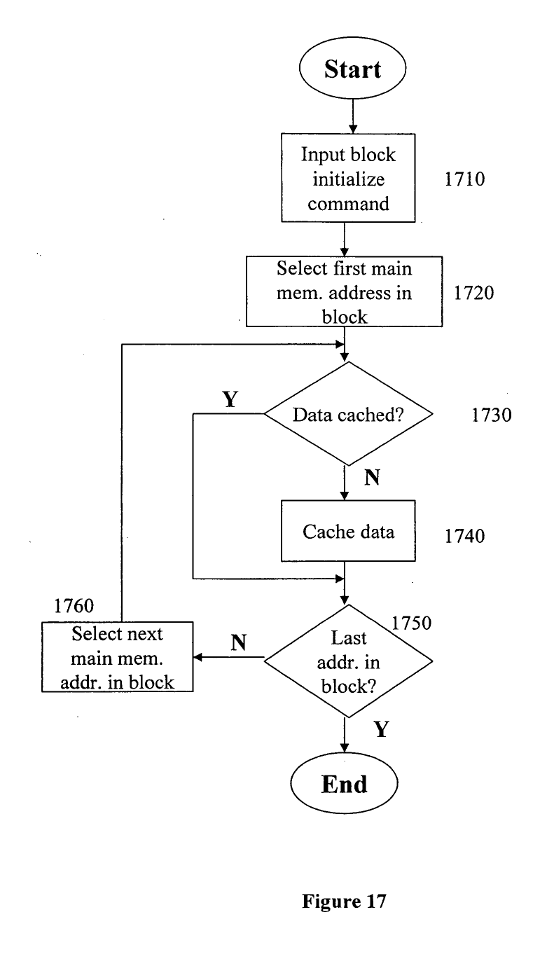

In a further preferred embodiment only the block initialize command is implemented for any type of cache memory, in a method similar to that described above for the block update command. Reference is now made to FIG. 17 which is a simplified flow chart of a method for caching main memory data of a specified block of a main memory in a cache memory. FIG. 17 shows the complete method performed when a block initialize command is received, combining the methods of FIGS. 12 and 14 above. In step 1710 the block initialize cache memory processing command is received. The block initialize command is implemented by performing background caching of data of the specified block of the main memory in the cache memory. The method of FIG. 17 ensures that the main memory data in the specified block of main memory is cached in the cache memory.

Steps 1720-1750 show a preferred embodiment for implementing the initialize command. In step 1720 the first address in the specified block of the main memory is selected. In step 1730 the main memory data in the selected address is checked to determine if the data is present in the cache memory. If the data is not currently cached, the main memory data is cached in the cache memory in step 1740. If the data is currently cached step 1740 is skipped. Step 1750 checks if all of the addresses in the specified block of the main memory have been processed. If not, the next address in the block is selected in step 1760, and the process continues at step 1730. If the end of the main memory block has been reached, the method ends.

An additional preferred embodiment of the present invention is a cache memory block preprocessing program instruction. The preprocessing program instruction is part of a processor instruction set, which can be inserted into an instruction sequence by the programmer. When the instruction is reached, during processing system operation, the instruction is executed, initiating background operations on the system cache memory. The programmer uses this instruction to prepare the cache memory for upcoming processor requirements. The preprocessing operation specifies a cache memory blockwise processing operation, and a memory block upon which the operation is performed. The memory block can be specified as part of the cache memory or of the main memory, as required by the specific processing operation. The preprocessing instruction is given a low priority, to prevent preprocessing instruction execution from interfering with higher priority instructions.

The block update, block invalidate, and block initialize operations each have a preferred embodiment as a program instruction. For the block update instruction, the block update operation is specified, and the specified memory block is block of ways of a cache memory. Executing the block update instruction consists of updating the data of a main memory in accordance with the data cached in the specified block of cache memory ways. For the block invalidate instruction, the block invalidate operation is specified, and the specified memory block is a block of cache memory ways. Executing the block invalidate instruction consists of invalidating cache memory data in the specified block of ways. For the block initialize instruction, the block initialize operation is specified, and the specified memory block is a block of main memory addresses. Executing the block initialize instruction consists of caching main memory data from the specified block of addresses into a cache memory.

A further preferred embodiment of the present invention is a compiler that supports a cache memory block preprocessing program instruction. The compiler compiles programs written using a predefined set of high-level instructions into executable form, where the instruction set includes a cache memory block preprocessing instruction or instructions. As above, the preprocessing instruction is a low priority instruction, whose operands define a cache memory blockwise processing operation and a memory block. Preferably, the instruction set contains preprocessing instructions for the block update, the block invalidate, and/or the block initialize operations.

Data caching is an effective tool for speeding up memory operations. However cache memory overhead operations can themselves introduce delays. In some cases these delays are foreseeable by the system designer, for example when large data vectors are repeatedly required by the processor. In these cases the required data remains stored in the main memory until required by the processor, and only then is moved into the cache memory while the processor idles and is unable to continue with instruction processing. Until now no effective tools have been available to eliminate or reduce these foreseeable delays. The cache memory preprocessing embodiments described above enable the system designer to perform background cache memory operations on blocks of the cache or main memory, and to prepare the cache memory for future processor requirements. The cache memory operations are triggered by a preprocessing command, and are performed in the background, generally at low priority, in a manner similar to the operation of a direct memory access (DMA) system. For example, a single preprocessing command issued by the processor can move a block of data from the main memory into the cache or copy-back a block of cache memory data into the main memory. Cache memory preprocessing reduces cache memory delays and improves processor efficiency, thereby improving overall system performance.

It is expected that during the life of this patent many relevant memory devices, background processing, data caching, and update policies will be developed and the scope of the terms “memory devices”, “background processing”, “data caching”, and “update policies” is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A cache memory preprocessor, for preparing an associative cache memory for use by a processor, said processor being arranged to access a main memory via data caching in said associative memory, said cache memory preprocessor comprising:
a command inputter, for receiving a multiple-way cache memory processing command from said processor; and
a command implementer associated with said command inputter, for performing background processing upon multiple ways of said cache memory in accordance with said multiple-way cache memory processing command.

2. A cache memory preprocessor according to claim 1, wherein said multiple-way cache memory processing command is a block update command and said command implementer comprises a block updater operable to implement said block update command upon a block of ways of said cache memory specified by said command by updating main memory data in accordance with data cached in said specified block of ways.

3. A cache memory preprocessor according to claim 2, wherein said block updater comprises:
a way checker, for determining for a given way of said cache memory if data cached in a said way is equivalent to corresponding main memory data; and
a data storer associated with said way checker, for carrying out said update command, when said data is not equivalent to the corresponding main memory data.

4. A cache memory preprocessor according to claim 1, wherein said cache memory comprises an n-way set associative memory.

5. A cache memory preprocessor according to claim 1, wherein said cache memory comprises a fully associative memory.

6. A cache memory preprocessor according to claim 1, wherein said cache memory comprises a direct mapped cache memory.

7. A cache memory preprocessor according to claim 3, wherein at least one way of said cache memory comprises a dirty bit to indicate whether said data is not equivalent to the corresponding main memory data and said way checker is operable to examine said dirty bit of said way.

8. A cache memory preprocessor according to claim 3, wherein said data storer is operable to store said updated data in said main memory at a main memory address associated with said cached data.

9. A cache memory preprocessor according to claim 7, wherein said data storer is further operable to reset said dirty bit, when data from said way is stored in said main memory to update said main memory data, whereby said main memory data and said cache memory date are caused to be equivalent.

10. A cache memory preprocessor according to claim 1, wherein said multiple-way cache memory processing command is a block invalidate command and said command implementer comprises a block invalidator operable to implement said block invalidate command upon a block of ways of said cache memory specified by said command by invalidating the data in said specified block of ways.

11. A cache memory preprocessor according to claim 10, wherein at least one way comprises a validity bit to indicate a validity status of said way, and wherein said invalidating comprises setting a validity bit of said way to invalid.

12. A cache memory preprocessor according to claim 1, wherein said multiple-way cache memory processing command is a block initialize command and said command implementer comprises a cache initializer operable to implement said block initialize command upon a specified block of said main memory, by caching main memory data of said specified block of main memory into said cache memory.

13. A cache memory preprocessor according to claim 12, wherein said cache initializer comprises:
a cache checker, for determining if data from a selected main memory address is present in said cache memory; and
a data cacher, for carrying out said data caching, if said data is not present in said cache memory.

14. A cache memory preprocessor according to claim 1, wherein said cache memory preprocessor is configured to operate with a segmented memory having a plurality of main memory segments, and wherein data caching is provided to each of said main memory segments by a cache memory section within said memory segment.

15. A cache memory preprocessor according to claim 14, connectable to said cache memory sections via an interconnector, the interconnector providing in parallel switchable connections between each of a plurality of processing agents to selectable ones of said cache memory sections.

16. A cache memory preprocessor according to claim 15, wherein said interconnector comprises a prioritizer operable to prevent simultaneous connection of more than one output to a memory segment by controlling access to said cache memory sections according to a priority scheme.

17. A background memory refresher, for updating main memory data in a main memory in accordance with data cached in a cache memory, wherein said cache memory is arranged in blocks, comprising:
a command inputter, for receiving a block update command; and
a block updater, associated with said command inputter, for performing background update operations blockwise from a specified block of said cache memory so as to update said main memory in accordance with data cached in said specified block of said cache memory.

18. A background memory refresher according to claim 17, wherein said cache memory comprises a cache memory selected from the group consisting of an n-way set associative cache memory, a fully associative cache memory, and a direct mapped cache.

19. A background memory refresher according to claim 17, wherein said block updater comprises:
a way checker, for determining for a given way if data cached in said way is equivalent to corresponding main memory data; and
a data storer associated with said way checker, for carrying out said updating when said data is not equivalent to the corresponding main memory data.

20. A background memory refresher according to claim 19, wherein at least one way of said cache memory comprises a dirty bit to indicate said equivalence status and said way checker is operable to examine said dirty bit of said way.

21. A background memory refresher according to claim 19, wherein said data storer is operable to store updated data resulting from said updating in said main memory at a main memory address associated with said updated data.

22. A background memory refresher according to claim 20, wherein said data storer is further operable to reset said dirty bit when updated data resulting from said updating is stored in said main memory.

23. A cache memory background block preloader, for preloading main memory data arranged in blocks into a cache memory, comprising:
a command inputter, for receiving a block initialize command; and
a cache initializer, for performing blockwise background caching of data of a specified block of main memory into said cache memory.

24. A cache memory background block preloader according to claim 23, wherein said cache initializer comprises:
a cache checker, for determining if data from a selected main memory address is present in said cache memory; and
a data cacher, for carrying out said data caching, if data from said selected main memory address is not present in said cache memory.

25. A cache memory background block preloader according to claim 23, said cache memory preloader being integrally constructed with a cache memory.

26. A system, for processing data from a segmented memory, comprising:
a segmented memory comprising a plurality of memory segments, said memory segments comprising a respective data section and a respective cache memory section;
a processor, for processing data, performing read and write operations to said segmented memory, and for controlling processing system components, and being arranged to access a memory segment via data caching in the respective cache memory section;
a cache memory preprocessor, associated with said processor, for preparing said cache memory sections for use by said processor by performing background processing upon multiple ways of at least one of said cache memory sections in accordance with a multiple-way cache memory processing command received from said processor; and
a switching grid-based interconnector associated with said segmented memory, for providing in parallel switchable connections between said processor and said cache memory preprocessor to selectable ones of said memory segments.

27. A processing system according to claim 26, wherein at least one of said cache memory sections comprises an n-way set associative memory.

28. A method for preparing a cache memory, by:
receiving a cache memory processing command to specify background processing of multiple ways of said cache memory; and
performing background processing upon multiple ways of said cache memory so as to implement said cache memory processing command.

29. A method for preparing a cache memory according to claim 28, further comprising controlling communications to said cache memory according to a priority scheme.

30. A method for preparing a cache memory according to claim 28, wherein said cache memory is arranged in blocks and said command comprises a block update command, and wherein implementing said block update command comprises updating main memory data in accordance with data cached in a specified block of said cache memory.

31. A method for preparing a cache memory according to claim 30, wherein each cache memory block comprises a block of ways, and wherein said updating comprises performing the following steps for each way in said specified block:
determining if data cached in said way is equivalent to corresponding main memory data; and
if said cached data and said corresponding main memory data are not equivalent, storing updated data in said main memory at a main memory address associated with said cached data.

32. A method for preparing a cache memory according to claim 31, wherein at least one way of said cache memory comprises a dirty bit to indicate said equivalence status and said step of determining comprises examining said dirty bit of said way.

33. A method for preparing a cache memory according to claim 32, further comprising resetting said dirty bit when updated data from said way is stored in said main memory.

34. A method for preparing a cache memory according to claim 28, wherein said cache memory is arranged in blocks and said command comprises a block invalidate command, and wherein implementing said block invalidate command comprises invalidating data in a block of said cache memory specified by said command.

35. A method for preparing a cache memory according to claim 34, each cache memory block comprises a block of ways and at least one way comprises a validity bit to indicate a validity status of said way, and wherein said invalidating comprises setting said validity bit of each way in said specified block to invalid.

36. A method for preparing a cache memory according to claim 28, wherein said main memory is arranged in blocks and said command comprises a block initialize command, and wherein implementing said block initialize command comprises caching main memory data of a specified main memory block in said cache memory.

37. A method for preparing a cache memory according to claim 36, wherein each main memory block corresponds to a block of addresses, and wherein said caching comprises performing the following steps for each main memory address of a specified block of main memory:
determining if the data of said main memory address is already cached in said cache memory; and
if said data is not cached in said cache memory, caching said data in said cache memory.

38. A method for updating main memory data from cached data in a cache memory, wherein said cache memory is arranged in blocks, by:
receiving a block update cache memory processing command; and
performing background update operations blockwise from a cache memory block specified in said command, so as to update said main memory in accordance with data cached in said specified block within said cache memory

39. A method for updating main memory data from cached data according to claim 38, wherein each cache memory block comprises a block of ways, and wherein said updating comprises performing the following steps for each way in said specified block of ways:
determining if data cached in said way is equivalent to corresponding main memory data; and
if said cached data and said corresponding main memory data are not equivalent, storing updated data in said main memory.

40. A method for caching main memory data of a main memory into a cache memory, wherein said main memory is arranged in blocks, by:
receiving a block initialize cache memory processing command; and
performing background blockwise caching of data of a main memory block specified in said command into said cache memory.

41. A method for caching main memory data of a specified block of a main memory in a cache memory according to claim 40, each main memory block corresponds to a block of addresses, and wherein said caching said data into said cache memory comprises performing the following steps for each main memory address of said specified main memory block:
determining if the data of said main memory address is already cached in said cache memory; and
if said data is not cached in said cache memory, caching said data into said cache memory.

42. A program instruction for cache memory block preprocessing, recorded or transmitted as a signal in or via a tangible medium, said signal comprising operands defining a cache memory blockwise processing operation and a memory block upon which said processing operation is to be performed.

43. A program instruction for cache memory block preprocessing according to claim 42, wherein said processing operation comprises a block update operation and said memory block comprises a specified block of ways of a cache memory, and wherein execution of said program instruction comprises updating the data of a main memory in accordance with data cached in said specified block of ways.

44. A program instruction for cache memory block preprocessing according to claim 42, wherein said processing operation comprises a block invalidate operation and said memory block comprises a specified block of ways of a cache memory, and wherein execution of said program instruction comprises invalidating the data in said specified block of ways.

45. A program instruction for cache memory block preprocessing according to claim 42, wherein said processing operation comprises a block initialize operation and said memory block comprises a specified block of addresses of a main memory, and wherein execution of said program instruction comprises caching the data of said specified block of main memory addresses into a cache memory.

46. A computer running a compiler which compiles a program instruction for cache memory block preprocessing into executable instruction sequences, said sequences comprising instructions from a predefined set of instructions, wherein said instruction set comprises a cache memory block preprocessing instruction having operands defining a cache memory blockwise processing operation and a memory block for performing said processing operation upon, and having low priority so as to prevent the execution of said preprocessing instruction from interfering with higher priority commands.

47. A computer running a compiler which compiles a program instruction for cache memory block preprocessing according to claim 46, wherein said processing operation comprises a block update operation and said memory block comprises a specified block of ways of a cache memory, and wherein execution of said program instruction comprises updating the data of a main memory in accordance with data cached in said specified block of ways.

48. A computer according to claim 46, wherein said processing operation comprises a block invalidate operation and said memory block comprises a specified block of ways of a cache memory, and wherein execution of said program instruction comprises invalidating the data in said specified block of ways.

49. A computer according to claim 46, wherein said processing operation comprises a block initialize operation and said memory block comprises a specified block of addresses of a main memory, and wherein execution of said program instruction comprises caching the data of said specified block of main memory addresses into a cache memory.
